(19) United States
(12) Patent Application Publication
(10) Pub. No.: US 2008/0094785 A1
(43) Pub. Date: Apr. 24, 2008

(54) COMMUNICATION DEVICE HOUSING SYSTEMS AND METHODS

(75) Inventors: Eric M. Nelson, Waterloo, NE (US); James Price, Alpharetta, GA (US); Hugh L. McCormack, Winder, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/551,504

(22) Filed: Oct. 20, 2006

(51) Int. Cl. H05K 5/00; G06Q 20/00; H05K 1/18

(52) U.S. Cl. 361/679; 361/764; 705/21

(57) ABSTRACT

A transaction system includes a peripheral device, a transaction terminal having a printed circuit board disposed within an enclosure, a housing attached with the enclosure, and a cable that couples the peripheral device with the printed circuit board. The peripheral device includes a wireless communication device, a memory device, or both. A method of providing wireless connectivity or auxiliary memory for a transaction terminal includes providing a wireless communication device or a memory device, providing a transaction terminal having a printed circuit board and an enclosure, coupling the wireless communication device or the memory device with the printed circuit board via a cable, placing the wireless communication device or memory device at least partially within a housing, and attaching the housing with the enclosure of the transaction terminal.

### BACKGROUND OF THE INVENTION

The present invention relates to transaction systems, and more particularly to devices and methods that provide wireless connectivity for a transaction terminal.

In the sale of goods or services by a merchant to a customer, point-of-sale or point-of-service (“POS”) devices are often used by the merchant to complete a transaction. Typically, such devices are connected to a host computer or processor via a wired network. However, the functionality of such devices can be limited in some instances, leading to undesirable inefficiency in certain commercial and retail environments. In many cases, transaction terminals do not provide a convenient solution for attaching useful peripheral equipment such as a wireless communication device or a memory stick. Accordingly, it may be difficult to move a POS device from one location to another or to use the device in various desired locations. Such limitations are sometimes present in currently used point-of-care (“POC”) terminals as well.

For these and other reasons, there is a need for systems and methods that provide wireless connectivity and peripheral container solutions for a transaction terminal that overcome the limitations of currently used techniques. Hence, among a number of other advantages apparent from the following description, embodiments of the present invention provides systems and methods for addressing the aforementioned deficiencies of the current approaches.

Embodiments of the instant invention address these and other unfulfilled needs by providing systems, devices, and methods for conveniently and efficiently imparting wireless connectivity and other peripheral functions to a transaction terminal.

### BRIEF SUMMARY OF THE INVENTION

Transaction terminals, including point-of-sale terminals, point-of-service terminals, and point-of-care terminals typically require connectivity with a host or other computer system. Often, such connectivity is provided by a wired connection. In other cases, where connectivity is provided by an external wireless device, there may be no effective or convenient approach for attaching the wireless communication device to the transaction terminal. Embodiments of the present invention provide housing and other support and containment elements for coupling a peripheral device, such as a wireless telephone or a memory stick, to a transaction terminal.

In a first aspect, embodiments of the present invention provide a transaction system that includes a peripheral device, and a transaction terminal having a reader, a printer, a touch sensor, a liquid crystal display, a printed circuit board, and an enclosure. The transaction system also includes a housing removably attachable with the enclosure, and a cable having a first interface that couples with the peripheral device and a second interface that couples with the printed circuit board. The housing can be configured to receive at least a portion of the peripheral device, and the peripheral device can include a wireless communication device or a memory device. In some aspects, the peripheral device can include a universal serial bus connector, and the first interface of the cable can include a universal serial bus port. In some aspects, the printer circuit board can include a five pin header, and the second interface of the cable can couple with the five pin header. A wireless communication device according to embodiments of the present invention can include a Wireless Fidelity device, a Bluetooth device, a Worldwide Interoperability for Microwave Access device, a General Packet Radio Service device, a Cellular Digital Packet Data device, a Code Division Multiple Access device, and the like. These devices can be configured to provide connectivity via their respective protocols. In some aspects, the housing includes a housing vent. The transaction system can also include a deformable holder assembly disposed within the housing, such that the deformable holder assembly is configured to support the peripheral device. The deformable holder assembly can include a holder assembly vent. In some aspects, the transaction terminal enclosure includes a bottom cover, and the housing is attachable to the bottom cover. The housing can be attached to a rearward portion of the bottom cover, and can tilt the rearward portion of the bottom cover upward by about 6 to 10 degrees. In some cases, the transaction system includes a point of sale system, a point of care system, or a point of service system.

In another aspect, embodiments of the present invention provide a method of providing wireless connectivity to a transaction terminal. The method can include providing a wireless communication device, providing a transaction terminal having a reader, a printer, a touch sensor, a liquid crystal display, a printed circuit board, and an enclosure, and coupling the wireless communication device with the printed circuit board via a cable. The method can also include placing the wireless communication device at least partially within a housing, and attaching the housing with the enclosure of the transaction terminal. In some cases, the wireless communication device includes a universal serial bus connector, the cable includes a universal serial bus port, and coupling the wireless communication device with the printed circuit board includes attaching the universal serial bus connector with the universal serial bus port. The printer circuit board can include a five pin header, and coupling the wireless communication device with the printed circuit board can include attaching the cable with the five pin header. The method can also include supporting the wireless communication device with a deformable holder disposed within the housing. In some cases, the method includes attaching the housing with the bottom cover, and may optionally include tilting a rearward portion of the bottom cover upward by about 6 to 10 degrees. In yet another aspect, embodiments of the present invention provide a system for coupling a peripheral device with a transaction terminal. The system can include, for example, a housing configured to receive at least a portion of the peripheral device, and a cable comprising a printed circuit board interface and a peripheral device interface.

A further understanding of the nature and advantages of the present invention may be realized by reference to the detailed description and claims when considered in connection with the drawings, wherein like reference numerals are used throughout the several drawings to refer to similar components. The drawings, which are not necessarily to scale, illustratively depict embodiments of the present invention and are not intended to limit the scope of the invention.

### BRIEF DESCRIPTION OF THE DRAWINGS

FIG. 1 illustrates a transaction terminal according to embodiments of the present invention.

FIG. 2 illustrates a transaction system according to embodiments of the present invention.

FIG. 3 illustrates a transaction system according to embodiments of the present invention.

FIG. 4 illustrates a transaction system according to embodiments of the present invention.

FIG. 5 illustrates a transaction system according to embodiments of the present invention.

### DETAILED DESCRIPTION OF THE INVENTION

Embodiments of the present invention provide housing and support elements for containing or holding a peripheral device relative to a transaction terminal. Often, such peripheral devices are configured to supply the transaction terminal with wireless connectivity to a wireless network or device.

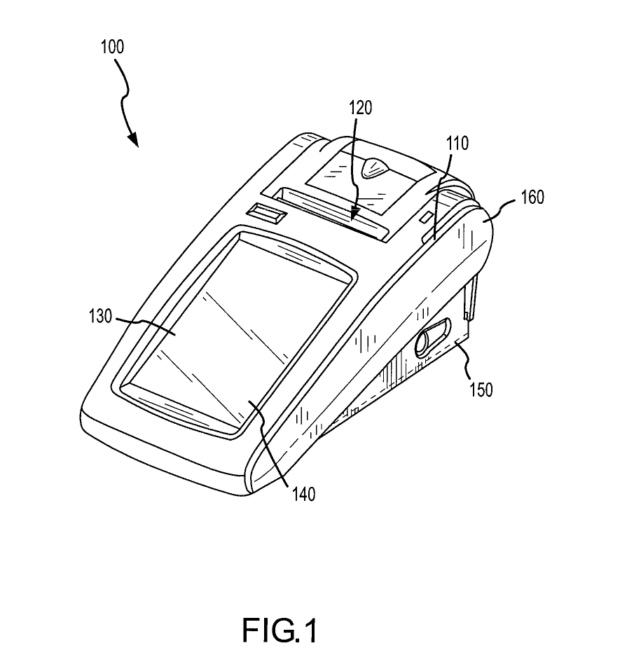

Turning now to the drawings, FIG. 1 shows a transaction terminal 100 according to embodiments of the present invention. Transaction terminal 100 includes a reader 110, a printer 120, a touch sensor 130, a liquid crystal display 140, a printed circuit board 150, and an enclosure 160. Reader 110 can be configured to read any of a variety of presentation instruments, including credit cards, debit cards, transaction cards, ATM cards, bank cards, stored value cards, gift cards, healthcare cards, and the like. Printer 120 may includes a chassis, a hinge and a paper cover assembly as described in U.S. Provisional Patent Application No. 60/747,362, the entire contents of which are herein incorporated by reference for all purposes.

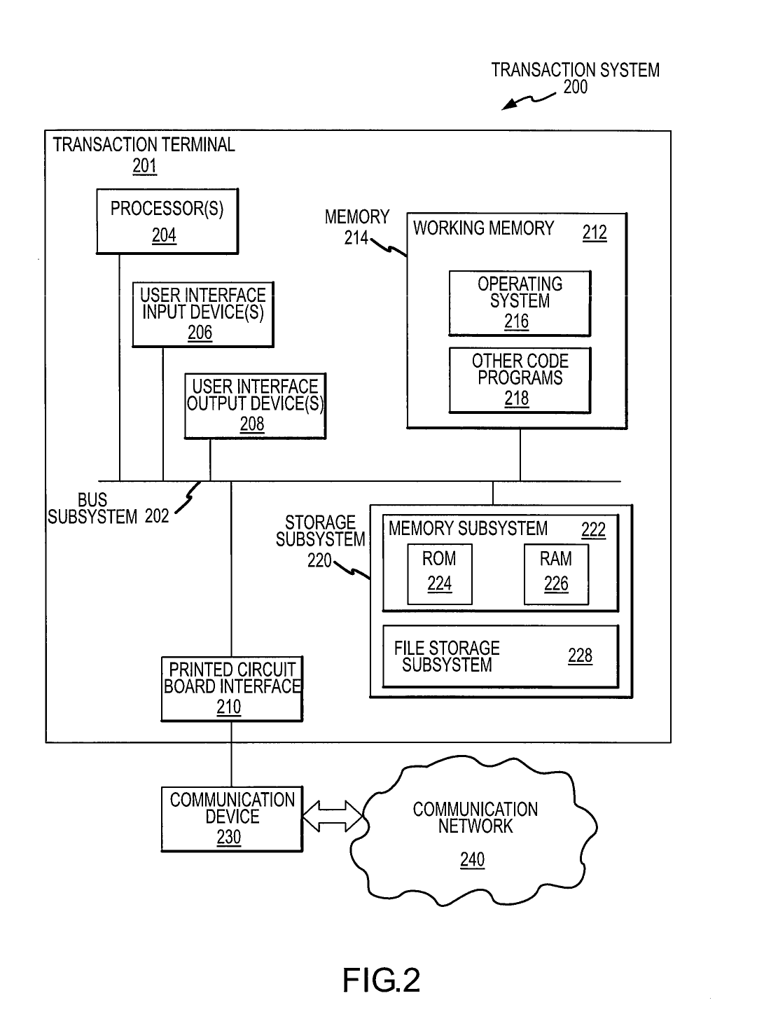

FIG. 2 is a simplified block diagram of an exemplary computer system that broadly illustrates how individual system elements for a transaction system 200 may be implemented in a separated or more integrated manner. Transaction system 200 includes a transaction terminal 201, which is shown comprised of hardware elements that are electrically coupled via a bus subsystem 202, including one or more processors 204, one or more input devices 206 such as user interface input devices, one or more output devices 208 such as user interface output devices, and a printed circuit board interface 210. In some embodiments transaction system 200 also comprises software elements, shown as being currently located within working memory 212 of memory 214, including an operating system 216 and other code 218, such as a program designed to implement methods of the invention.

Likewise, in some embodiments transaction system 200 may also include a storage subsystem 220 that can store the basic programming and data constructs that provide the functionality of the various embodiments of the present invention. For example, software modules implementing the functionality of the methods of the present invention, as described herein, may be stored in storage subsystem 220. These software modules are generally executed by the one or more processors 204. In a distributed environment, the software modules may be stored on a plurality of computer systems and executed by processors of the plurality of computer systems. Storage subsystem 220 can include memory subsystem 222 and file storage subsystem 228. Memory subsystem 222 may include a number of memories including a main random access memory (RAM) 226 for storage of instructions and data during program execution and a read only memory (ROM) 224 in which fixed instructions are stored. File storage subsystem 228 can provide persistent (non-volatile) storage for program and data files, and may include tangible storage media which may optionally embody merchant, customer, supplier, patient, provider, payer, or other transactional, healthcare, or financial data. File storage subsystem 228 may include a hard disk drive, a floppy disk drive along with associated removable media, a Compact Digital Read Only Memory (CD-ROM) drive, an optical drive, DVD, CD-R, CD-RW, solid-state removable memory, other removable media cartridges or disks, and the like. One or more of the drives may be located at remote locations on other connected computers at other sites coupled to transaction system 200. The modules implementing the functionality of the present invention may be stored by file storage subsystem 228. In some embodiments, the software or code will provide protocol to allow the transaction system 200 to communicate with communication network 230 via printed circuit board interface 210 and communication device 230.

It is appreciated that system 200 can be configured to carry out various methods of the present invention. For example, processor component or module 204 can be a microprocessor control module configured to receive financial or healthcare transaction signals from input device or module 206, and transmit financial or healthcare transaction signals to output device or module 208 and/or interface device or module 210. Each of the devices or modules of the present invention can include software modules on a computer readable medium that is processed by a processor, hardware modules, or any combination thereof. Any of a variety of commonly used platforms, such as Windows, MacIntosh, and Unix, along with any of a variety of commonly used programming languages, may be used to implement the present invention.

User interface input devices 206 may include, for example, a touchpad, a keyboard, pointing devices such as a mouse, a trackball, a graphics tablet, a scanner, a joystick, a touchscreen incorporated into a display, audio input devices such as voice recognition systems, microphones, and other types of input devices. User input devices 206 may also download a computer executable code from a tangible storage media or from communication network 230, the code embodying any of the methods of the present invention. It will be appreciated that terminal software may be updated from time to time and downloaded to the terminal as appropriate. In general, use of the term “input device” is intended to include a variety of conventional and proprietary devices and ways to input information into transaction system 200.

User interface output devices 206 may include, for example, a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide a non-visual display such as via audio output devices. In general, use of the term “output device” is intended to include a variety of conventional and proprietary devices and ways to output information from computer system 200 to a user.

Bus subsystem 202 provides a mechanism for letting the various components and subsystems of transaction system 200 communicate with each other as intended. The various subsystems and components of transaction system 200 need not be at the same physical location but may be distributed at various locations within a distributed network. Although bus subsystem 202 is shown schematically as a single bus, alternate embodiments of the bus subsystem may utilize multiple busses.

Printed circuit board interface 210 can provide an interface to an outside device such as communication device 230, which can in turn provide an interface to other outside networks and/or other devices. Outside communication network 230 can be configured to effect communications as needed with various entities. It thus receives an electronic packet from transaction system 200 and transmits any information as needed back to transaction system 200. In addition to providing such infrastructure communications links internal to the system, the communications network system 230 may also provide a connection to other networks such as the internet and may comprise a wired, wireless, modem, and/or other type of interfacing connection.

It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed. Transaction terminal system 200 itself can be of varying types including a computer terminal, a personal computer, a portable computer, a workstation, a network computer, or any other data processing system. Due to the ever-changing nature of computers and networks, the description of transaction system 200 depicted in FIG. 2 is intended only as a specific example for purposes of illustrating one embodiment of the present invention. Many other configurations of transaction system 200 are possible having more or less components than the computer system depicted in FIG. 2. Relatedly, any of the hardware and software components discussed above can be integrated with or configured to interface with other practice management systems used at merchant locations.

It is understood that a transaction terminal 201 according to embodiments of the present invention may include any element, configuration, or functionality of a point-of-sale, point-of-service, or point-of-care device as described in U.S. Patent Application Ser. No. 60/147,899, Ser. Nos. 09/634,901, 10/358,615, 10/116,686, 10/116,689, 10/116,891, 10/116,735, 11/153,218, and 11/370,202, the entire contents of each of which are incorporated herein by reference for all purposes.

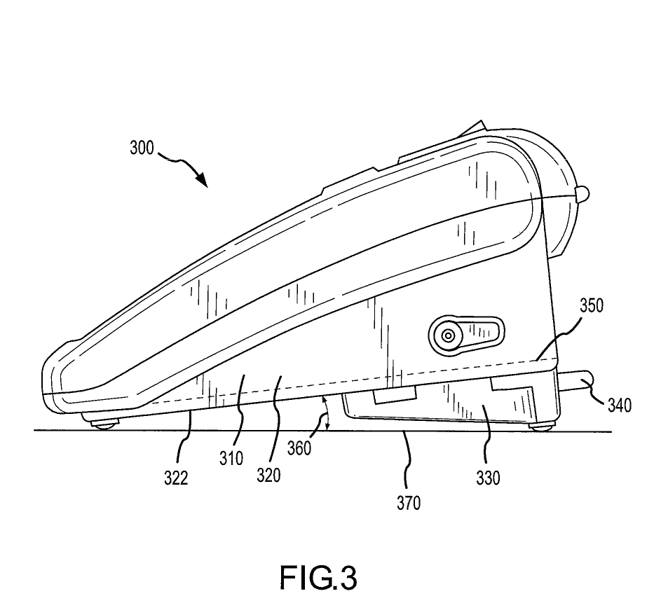

A transaction system 300 according to embodiments of the present invention is illustrated in FIG. 3. Transaction system 300 includes a transaction terminal 310 and a housing 330. Transaction terminal 310 can include a enclosure 320 having a bottom cover 322, and a printed circuit board 350 disposed within enclosure 320. Transaction system 300 may also include a peripheral device 340, such as a wireless communication device, disposed at least partially within housing 330. As shown here, housing 330 can be attached with a rearward portion of bottom cover 322, so as to tilt the rearward portion of bottom cover 322 in an upward direction relative to a resting surface 370. In some embodiments, a tilt angle 360 is within a range from about 6 to 10 degrees. In some cases, the housing can be configured to tilt the transaction terminal any desired amount between 0 and 90 degrees. Typically, housing 330 and other elements disposed therein can act as a protective cover to contain or support peripheral device 340. Embodiments of the present invention encompass any of a variety of peripheral devices, including communication devices and memory devices. For example, a peripheral device can include a wireless communication device such as a Wireless Fidelity device, a Bluetooth device, a Worldwide Interoperability for Microwave Access device, a General Packet Radio Service device, a Cellular Digital Packet Data device, or a Code Division Multiple Access device. In some cases, the peripheral device includes a radio frequency device. Relatedly, a peripheral device can include a memory device such as a memory stick, a flash drive, a jump drive, a microdrive, a portable memory device, and the like. In some instances, the peripheral device includes or is integrated with a universal serial bus interface. Peripheral devices can be constructed for ease of transport, and may be configured as a keyfob or attached with a lanyard. In some embodiments, a peripheral device includes a wireless communication device in combination with a memory device.

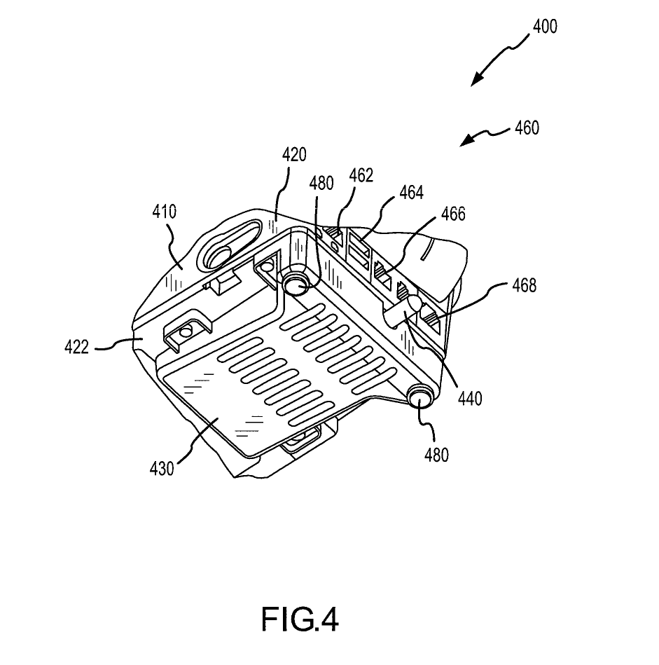

FIG. 4 shows a transaction system 400 according to embodiments of the present invention. Transaction system 400 includes a transaction terminal 410 and a housing 430. Transaction terminal 410 can include a enclosure 420 having a bottom cover 422, and one or more interface connectors 460, such as a telco interface connector 462, a USB host interface connector 464, a COM interface connector 466, and an ethernet interface connector 468. In some cases, the terminal may include a USB mini connector. Transaction system 400 may also include a peripheral device 440, such as a wireless communication device or a portable memory device, disposed at least partially within housing 430. Housing can be manufactured from any desired material. In some cases, the housing includes ABS with UL 94V0. The housing can be configured for desired thermal distortion temperature characteristics, moisture resistance, density, hardness, dimension stability, impact strength, roughness, water absorption rate, chemical resistance, alkali and acidic resistance, weathering resistance, UL light resistance, and other material characteristics. Housing 430 can include a plurality of feet 480, which is some cases are manufactured from or include a rubber material. The feet can be configured to provide optimal or desired vibration absorption characteristics, coefficients of friction, wear resistance properties, and temperature resistance profiles. The feet can be made of IIR (butyl rubber), NBR (nitrile-butadiene rubber), and/or PCV (polyvinyl chloride). In some cases, the feet have a hardness of Shore A 60±5.

Transaction system 400 can be used to carry out any of a variety of financial or healthcare transactions. For example, a retailer such as Macy's® can provide a customer with a debit card or account number that is linked with the customer's checking account. When the customer shops at a Macy's® store or affiliate, a sales representative or the customer can swipe the customer's debit card, drivers license, or other personal identification instrument that is associated with the customer's debit card or account number through the reader of the transaction terminal. The transaction system can communicate over a variety of financial or healthcare networks in order to authorize and complete the transaction, including credit card networks, demand deposit account (“DDA”) networks, private label networks, in store card enrollment networks, healthcare enrollment networks, and the like. For example, transaction system embodiments according to the present invention are well suited to support or execute debit transactions from demand deposit accounts as described in U.S. patent application Ser. Nos. 10/825,971, 10/825,960, and 10/825,950, all filed Apr. 16, 2004, the entire contents of each of which are incorporated herein by reference for all purposes.

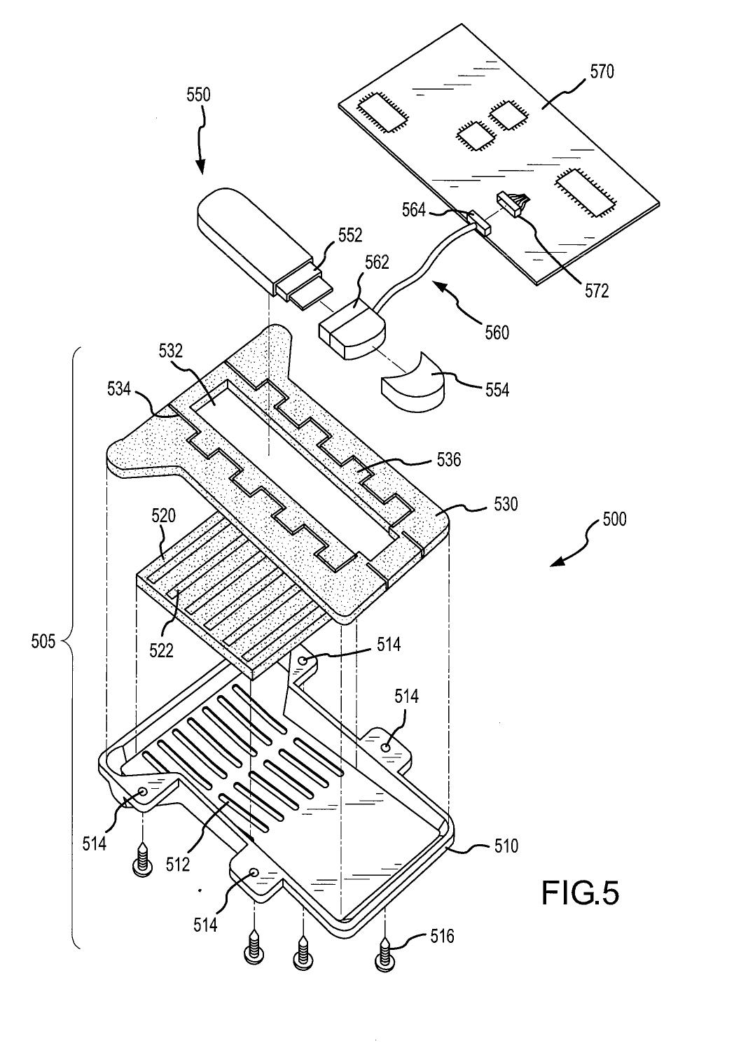

Components of a transaction system 500 according to embodiments of the present invention are depicted in FIG. 5. Transaction system 500 includes a housing assembly 505, a peripheral device 550, and a cable 560. Housing assembly 500 includes a housing 510 having a plurality of vents 512, a plurality of feet (not shown), and a plurality of fastener apertures 514. Housing 510 can be coupled with an enclosure of a transaction terminal via any suitable fastener or fastening system, including screws, pins, nails, clips, snaps, and the like. As shown here, housing 510 can be coupled with transaction terminal enclosure via a plurality of fastener screws 516 that engage threaded inserts or surfaces in the bottom cover. Housing assembly also includes a first holder 520 and a second holder 530. First holder 520 includes a plurality of vents 522. Apertures or vents 512, 522 can allow heat to dissipate from the interior of housing assembly 500, as heat can be generated by a transaction terminal or peripheral device 550. Similarly, apertures or vents 512, 522 can allow for airflow through housing assembly 500. In some cases, first holder 520 is manufactured from or includes a deformable material such as a polyurethane foam. Second holder 530 includes a central aperture 532 and a plurality of precut sections 536 defined at least in part by scorings 534. In some cases, second holder 530 includes a tear away foam block that is prescored or precut into small pieces or cubes, which allow a user to customize the dimensions of the holder so as to accommodate communication devices of various sizes. Peripheral device 550, which may be a wireless communication device or a memory device such as a memory stick, includes a communication connection 552 such as a universal serial bus connection or port. Communication device 550 may also include a removable cap 554. Housing assembly 505 or components thereof can be configured for removable attachment with a transaction terminal enclosure. Similarly, housing assembly 505 or components thereof can be configured to receive or house at least a portion of a wireless communication device or other peripheral unit.

Cable 560 can include a first interface 562 that couples with the peripheral device 550 and a second interface 564 that couples with the printed circuit board 570. For example, cable 560 can include a communication port or connection 562 at one end, and a communication connection or port 564 at another end. Typically, communication connection or port 564 is configured for attachment with an interface or internal component of a transaction terminal. For example, communication connection 564 can be configured for attachment with a port or connection 572 of a printed circuit board 570 disposed within a transaction terminal. Relatedly, port 572 is often disposed at or near an aperture in an enclosure of the transaction terminal enclosure. In some cases, port or header 572 may include a detachable or disposable cover, which may be removed by the user prior to connecting the cable. For example, the header can be accessed by removing a disposable cover that is removably attached with the bottom cover. Communication port 562 can include, for example, a universal serial bus port or connection. Communication connection 564 can include, for example, a five pin connection configured for attachment with a five pin header or port of a printed circuit board. Any of a variety of connectivity means can be used to provide communication between the peripheral device 550 and the printed circuit board 570 or other transaction terminal component. In addition to universal serial bus connections and five pin connections, suitable modalities for connectivity include FireWire or IEEE 1394, WiFi, infrared, radio frequency, or other wired or wireless communication means.

Although certain preferred embodiments and methods have been disclosed herein, it will be apparent from the foregoing disclosure to those skilled in the art that variations, modifications, alternative constructions, and equivalents of such embodiments and methods may be made without departing from the true spirit and scope of the invention. Therefore, the above description should not be taken as limiting the scope of the invention which is defined by the appended claims.

What is claimed is:

1. A transaction system, comprising:
a peripheral device;
a transaction terminal comprising a reader, a printer, a touch sensor, a liquid crystal display, a printed circuit board, and an enclosure;
a housing removably attachable with the enclosure, wherein the housing is configured to receive at least a portion of the peripheral device; and
a cable comprising a first interface that couples with the peripheral device and a second interface that couples with the printed circuit board;
wherein the peripheral device comprises a wireless communication device or a memory device.

2. The transaction system according to claim 1, wherein the peripheral device comprises a universal serial bus connector, and the first interface of the cable comprises a universal serial bus port.

3. The system according to claim 1, wherein the printer circuit board comprises a five pin header, and the second interface of the cable couples with the five pin header.

4. The transaction system according to claim 1, wherein the wireless communication device comprise a member selected from the group consisting of a Wireless Fidelity device, a Bluetooth device, a Worldwide Interoperability for Microwave Access device, a General Packet Radio Service device, a Cellular Digital Packet Data device, and a Code Division Multiple Access device.

5. The transaction system according to claim 1, wherein the housing comprises a housing vent.

6. The transaction system according to claim 1, further comprising a deformable holder assembly disposed within the housing, wherein the deformable holder assembly is configured to support the peripheral device.

7. The transaction system according to claim 6, wherein the deformable holder assembly comprises a holder assembly vent.

8. The transaction system according to claim 1, wherein the enclosure comprises a bottom cover, and the housing is attachable to the bottom cover.

9. The transaction system according to claim 8, wherein the housing is attached to a rearward portion of the bottom cover, and tilts the rearward portion of the bottom cover upward by about 6 to 10 degrees.

10. The transaction system according to claim 1, wherein the transaction system comprises a point of sale system, a point of care system, or a point of service system.

11. A method of providing wireless connectivity to a transaction terminal, comprising:
providing a wireless communication device;
providing a transaction terminal comprising a reader, a printer, a touch sensor, a liquid crystal display, a printed circuit board, and an enclosure;
coupling the wireless communication device with the printed circuit board via a cable;
placing the wireless communication device at least partially within a housing; and
attaching the housing with the enclosure of the transaction terminal.

12. The method according to claim 11, wherein the wireless communication device comprises a universal serial bus connector, the cable comprises a universal serial bus port, and coupling the wireless communication device with the printed circuit board comprises attaching the universal serial bus connector with the universal serial bus port.

13. The method according to claim 11, wherein the printer circuit board comprises a five pin header, and coupling the wireless communication device with the printed circuit board comprises attaching the cable with the five pin header.

14. The method according to claim 11, wherein the wireless communication device comprise a member selected from the group consisting of a Wireless Fidelity device, a Bluetooth device, a Worldwide Interoperability for Microwave Access device, a General Packet Radio Service device, a Cellular Digital Packet Data device, and a Code Division Multiple Access device.

15. The method according to claim 11, wherein the housing comprises a housing vent.

16. The method according to claim 11, further comprising supporting the wireless communication device with a deformable holder disposed within the housing.

17. The method according to claim 16, wherein the deformable holder assembly comprises a holder assembly vent.

18. The method according to claim 11, wherein the transaction terminal enclosure comprises a bottom cover, further comprising attaching the housing with the bottom cover.

19. The method according to claim 18, wherein attaching the housing with the bottom cover comprises tilting a rearward portion of the bottom cover upward by about 6 to 10 degrees.

20. The method according to claim 11, wherein the transaction system comprises a point of sale system, a point of care system, or a point of service system.

21. A system for coupling a peripheral device with a transaction terminal, comprising:
a housing configured to receive at least a portion of the peripheral device; and
a cable comprising a printed circuit board interface and a peripheral device interface.
